(19) United States
(12) Patent Application Publication
(10) Pub. No.: US 2007/0239557 A1
(43) Pub. Date: Oct. 11, 2007

(54) Fill-up operation used in electronic content delivery

(76) Inventor: Mark E. Phillips, Seattle, WA (US)

Correspondence Address: OLYMPIC PATENT WORKS PLLC, P.O. BOX 4277, SEATTLE, WA, 98104, US

(21) Appl. No.: 11/394,153

(22) Filed: Mar. 30, 2006

(51) Int. Cl. G06Q 30/00

(52) U.S. Cl. 705/26

(57) ABSTRACT

One embodiment of the present invention is a fill-up operation provided by automated content-delivery systems to facilitate accurate, fast, and efficient downloading of content to portable, electronic, content-rendering devices. The fill-up operation allows a user of a portable, electronic, content-rendering device to depress or tough a single button to invoke content download from a connected automated content-delivery system. Content may be deleted from the portable, electronic, content-rendering device to facilitate download of new content from the portable, electronic, content-rendering device, the deletion occurring according to preferences previously specified by the user and/or criteria inferred by the portable, electronic, content-rendering device. Content may be selected for download to the portable, electronic, content-rendering device according preferences previously specified by the user as well as criteria inferred by, and maintained by, the automated content-delivery system.

### TECHNICAL FIELD

The present invention relates to electronic content delivery and, in particular, to a method for transferring content to a portable, electronic device.

### BACKGROUND OF THE INVENTION

Portable, hand-held, content-rendering devices have achieved spectacular market penetration during the past several years. Such devices include Apple iPod® music players, and similar devices produced by many other consumer-electronics manufacturers, portable CD and DVD players, and a large variety of electronic devices that provide for information exchange and information display. The capacities for content storage and bandwidths for downloading content provided by these relatively recently introduced portable devices have outpaced distribution channels for retailing content to portable-device users. Moreover, current distribution channels and information-exchange methods are relatively static, and do not provide for dynamic and flexible distribution of content and information exchange that mirrors the dynamic and often geographically independent patterns of use of these portable devices. Many automated content-delivery systems provide interfaces that require a user to navigate through various menu systems and select, item-by-item, content items for download and purchase. In a variety of emerging content-distribution environments, including automated content-delivery kiosks located in traditional retail stores, users may have relatively little time to spend interacting with the automated content-delivery system in order to download electronic content to their portable, electronic devices, making many current, automated content-delivery systems unattractive and impractical for downloading needs of potential customers. The so-far untapped potential of the recently introduced portable content-rendering devices represents a relatively large, unexploited market for flexible communications applications and for flexible and dynamic marketing, retailing, and distribution of content to a very large population of potential content consumers. For this reason, manufacturers, retailers, and developers of applications for, and users of, portable electronic content-rendering devices have all recognized the need for effective tools and features to facilitate fast and efficient selection, purchase, and downloading of content to portable electronic content-rendering devices and other portable devices.

### SUMMARY OF THE INVENTION

One embodiment of the present invention is a fill-up operation provided by automated content-delivery systems to facilitate accurate, fast, and efficient downloading of content to portable, electronic, content-rendering devices. The fill-up operation allows a user of a portable, electronic, content-rendering device to depress or tough a single button to invoke content download from a connected automated content-delivery system. Content may be deleted from the portable, electronic, content-rendering device to facilitate download of new content from the portable, electronic, content-rendering device, the deletion occurring according to preferences previously specified by the user and/or criteria inferred by the portable, electronic, content-rendering device. Content may be selected for download to the portable, electronic, content-rendering device according preferences previously specified by the user as well as criteria inferred by, and maintained by, the automated content-delivery system.

### BRIEF DESCRIPTION OF THE DRAWINGS

FIG. 1 shows an exemplary kiosk for automated retailing and distribution of content.

FIG. 2 shows a representative portable electronic content-rendering device.

FIG. 3 illustrates the types of remote devices to which a portable electronic content-rendering device may interconnect for downloading content, exchanging information, uploading content, and for carrying out any of a wide variety of different types of transactions.

FIGS. 4A-F include control-flow diagrams that illustrate one embodiment of a fill-up operation in which content is downloaded from a content server, kiosk, or other automated content provider to a portable electronic device.

### DETAILED DESCRIPTION OF THE INVENTION

The present invention is related to delivery of content to a portable, electronic device by an automated, content delivery system, such as an automated kiosk, content server, or other content delivery system. In many systems, users need to browse complex menus to make content selections in order to download content to their portable, electronic devices. In many cases, users lack time for lengthy content-selection interaction with an automated content delivery system, but also do not wish to spend time deleting unwanted content form their devices, or miss opportunities to receive current offerings. Embodiments of the present invention include a variety of content provision methods and systems that feature a fill-up operation that allows a user to fill his or her portable, electronic device with content from a content delivery system in a single request operation, without lengthy interaction with the content delivery system, while still obtaining desirable content.

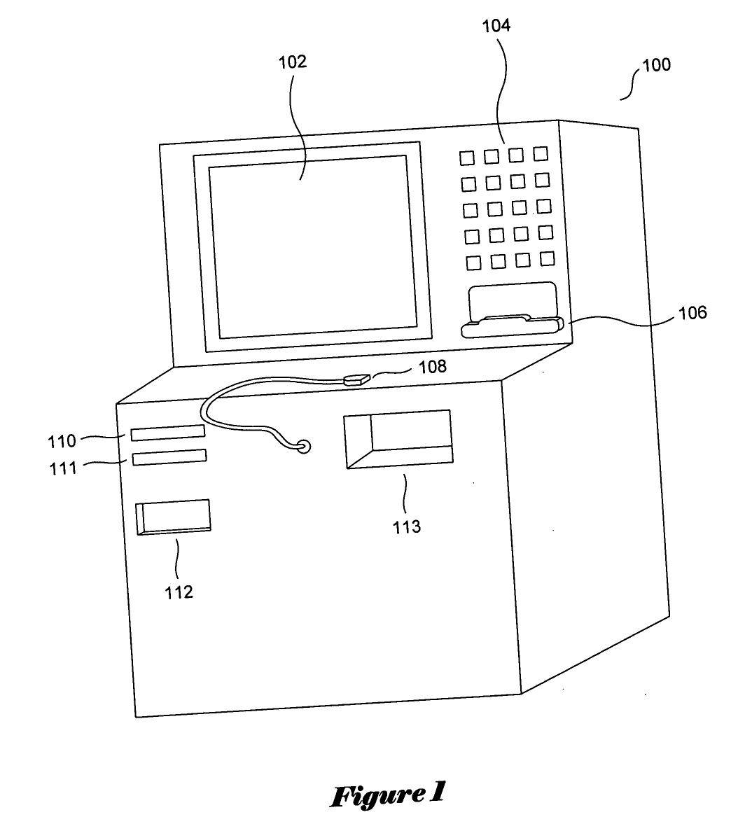

FIG. 1 shows an exemplary kiosk for automated retailing and distribution of content that represents one system embodiment of the present invention. As shown in FIG. 1, the kiosk 100 includes: (1) a display screen 102 for displaying user interfaces, content, and other information; (2) one or more various user-input means 104, such as a key pad, touch screen, or other input means; (3) a card reader 106; (4) an electronic port 108, such as a USB connector; (5) compact-disk trays 110-111; and (6) various additional ports and/or receptacles for various types of portable devices 112-113, including wireless connection features, such as RF transceivers. A wide variety of different kiosk implementations are possible. For example, the user input means may be created with the display screen 102 when the display screen has touch-screen capabilities. As another example, a kiosk may feature a much wider variety, and greater number, of ports and other electronic connections to allow users to connect many different portable devices of different types. Internally, the kiosk includes at least one processor, memory, an operating system running on the one or more processors, one or more mass storage devices, typically one or more communications links that link the kiosk with a central content storage and distribution system, and a kiosk control program. Kiosks provide a convenient, low-overhead means for retailers to sell and distribute content to users of portable electronic content-rendering devices.

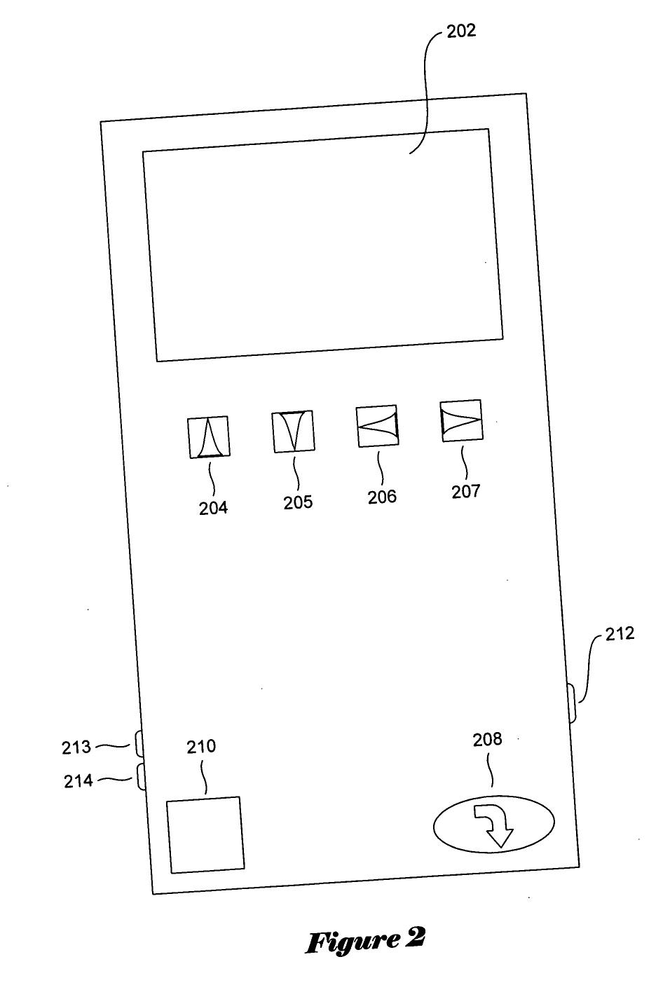

FIG. 2 shows a representative portable electronic content-rendering device. Such devices typically include a display area 202 for displaying textual and graphical information, including lists of content, photographs and video, account activity information, information about transactions, virtual-store catalogs, and other information useful to portable-device users. Devices include navigational buttons, such as navigational buttons 204-207 shown for the device in FIG. 2, and other buttons or input features, such as buttons that allow options to be highlighted and selected. In addition to a display screen 202, such devices typically include one or more output ports 212 for outputting audio signals to headphones or speakers, and one or more input ports 213 and 214 to allow the device to be interconnected with a personal computer, retailing kiosk, modem, or other such electronic devices. In many cases, portable electronic content-rendering devices additionally include internal antennas to allow the devices to interconnect with remote devices via radio-frequency signals, and may additionally include sensors and light-transmission features for optical interconnections with remote devices. Portable electronic content-rendering devices, such as the device shown in FIG. 2, generally include large amounts of internal data storage, typically including electronic memory and magnetic-disk-based mass-storage devices.

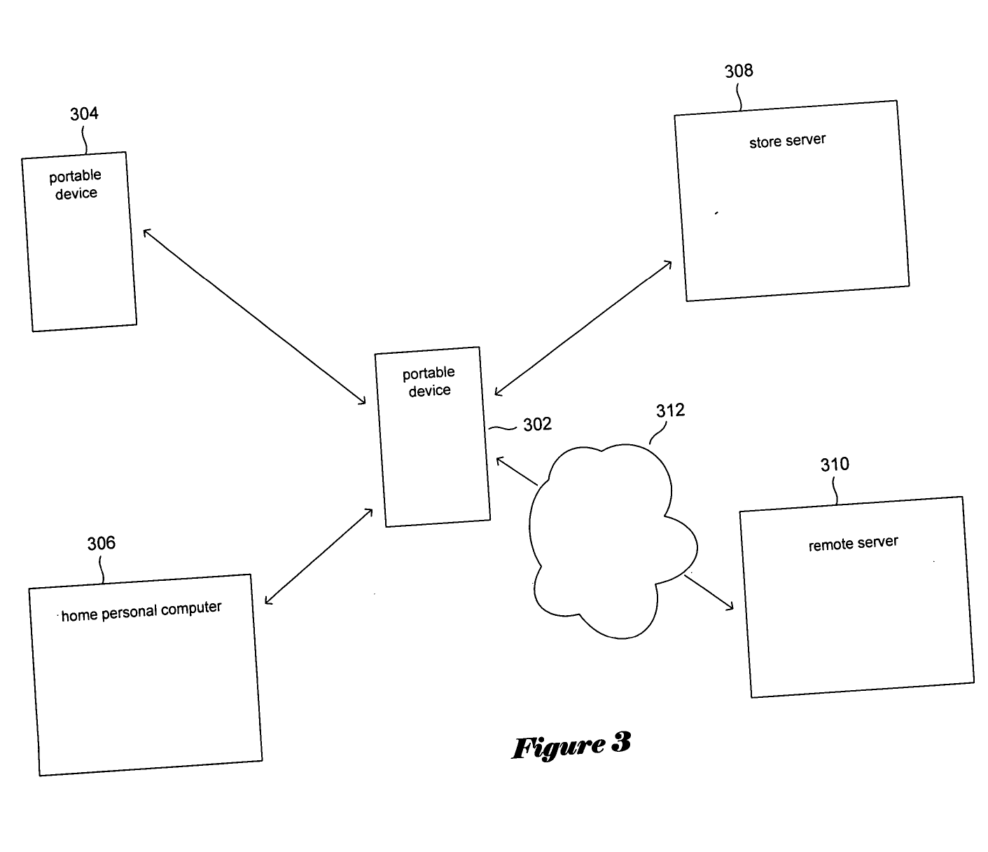

FIG. 3 illustrates the types of remote devices to which a portable electronic content-rendering device may interconnect for downloading content, exchanging information, uploading content, and for carrying out any of a wide variety of different types of transactions. As shown in FIG. 3, a portable electronic content-rendering device 302 may interconnect with: (1) another portable electronic content-rendering device 304 in a peer-to-peer fashion via a wireless connection, an optical connection, or a cable-mediated electronic connection; (2) a personal computer 306 via wireless, optical, or cable connection; (3) a retail server or retailing kiosk 308 via a wireless, optical, or cable connection; and (4) a remote server or other computing system 310 via any of a wide variety of different types of network and internet connections 312, including connections to the remote server or computer system through a local personal computer, modem, or other electronic device.

As discussed above, current interfaces provided by kiosks and other automated content-delivery systems may be rather cumbersome, and require lengthy interaction with a user in order for the user to locate and download desirable content onto the user's portable, electronic, content-rendering device. In many environments, users may not have either the time or interest to browse through complex menus and select content items for download. Embodiments of the present invention address this problem by providing a fill-up operation, analogous to filling up an automobile at a gas station, by which a user can, in one simple request, obtain a large amount of content from a content-delivery system. In many of these environments, a user first subscribes to the content-delivery system for receiving content of various, selected types. In these embodiments of the present invention, the user may specify preferences for content, by specific selection, by selection of content types and categories, or through usage and purchase patterns that allow the content-delivery system to infer the user's preferences over time. In addition, the content-delivery system may develop additional criteria for choosing content to download to a user's portable, content-rendering device.

The fill-up operation of the present invention is facilitated, in many embodiments of the present invention, by a fill-up button located on, or displayed by, a user's portable, content-rendering, electronic device. For example, referring again to FIG. 2, the button 210 in FIG. 2 may be allocated for the fill-up operation, or, in alternative embodiments, a fill-up button or selection may be displayed on the display area 202 for selection by a selection button 208. Many alternative embodiments for providing user selection of the fill-up function are possible.

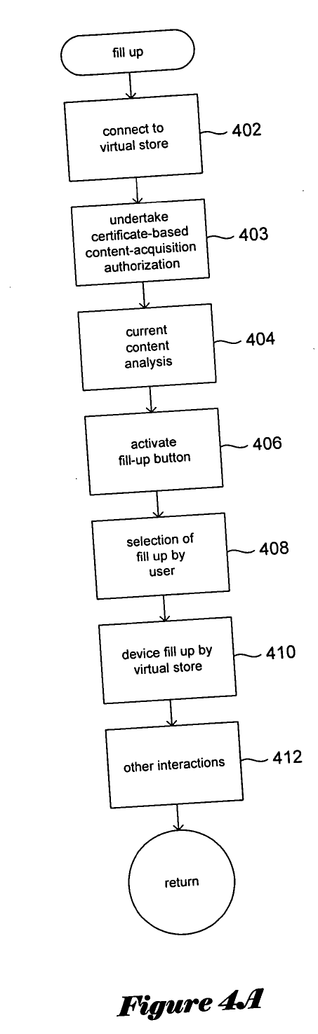

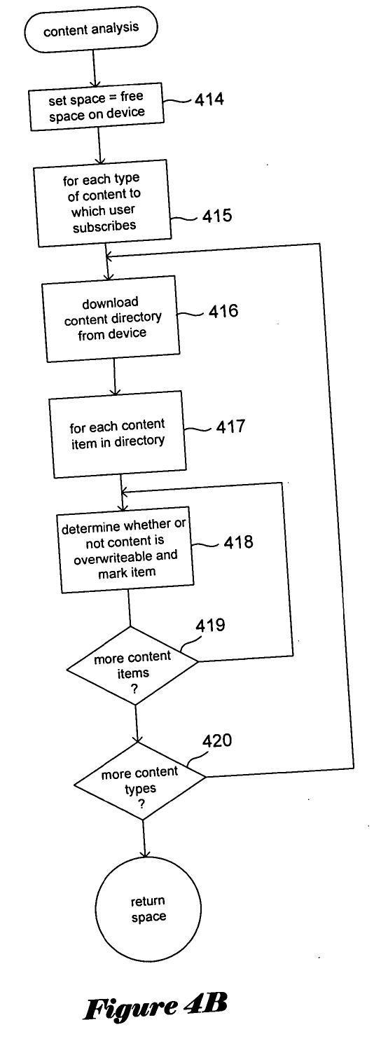

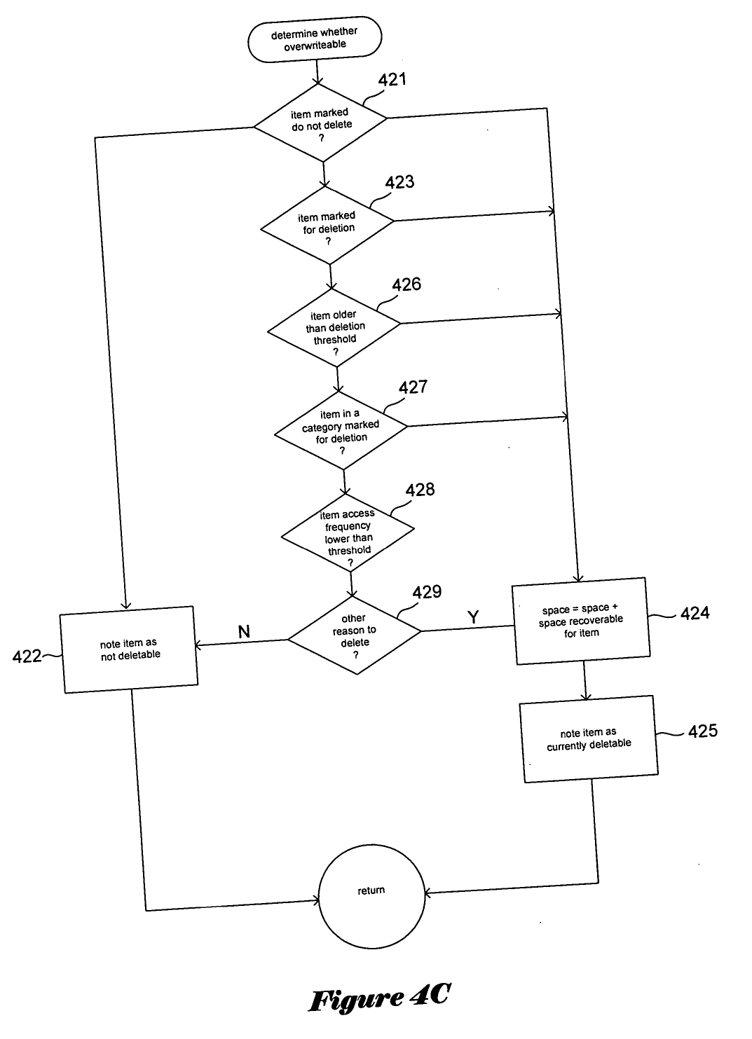

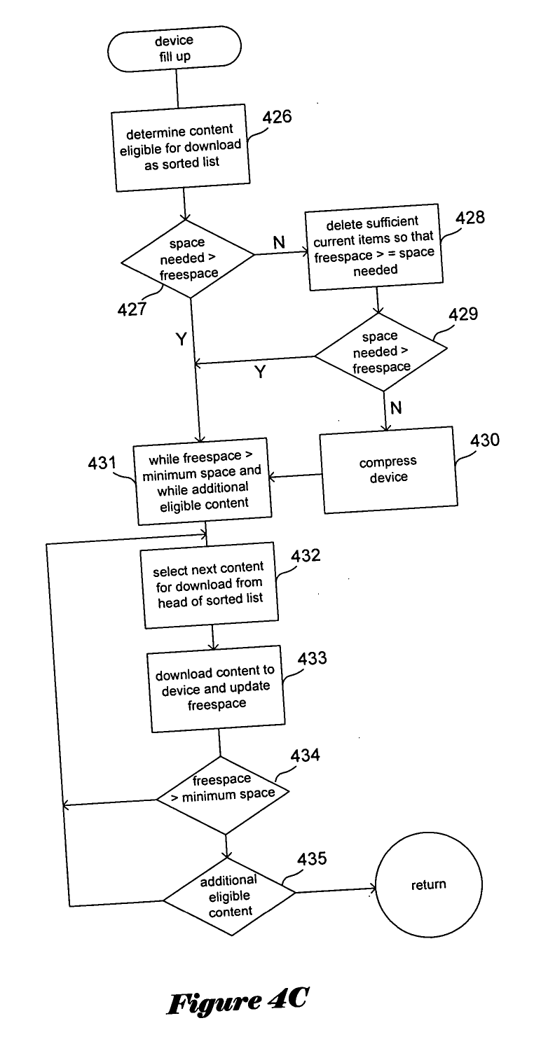

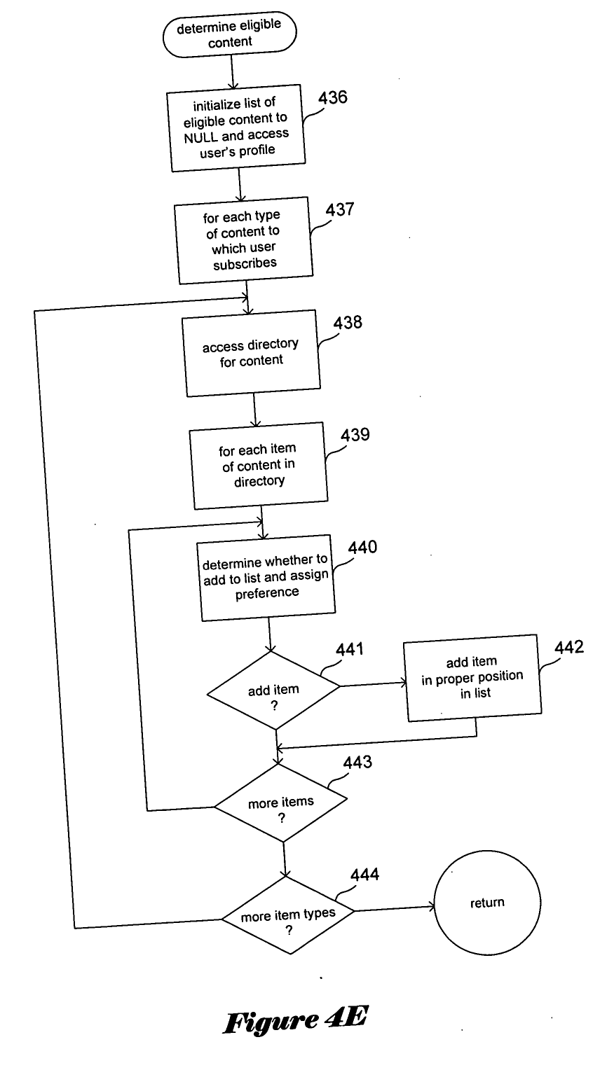

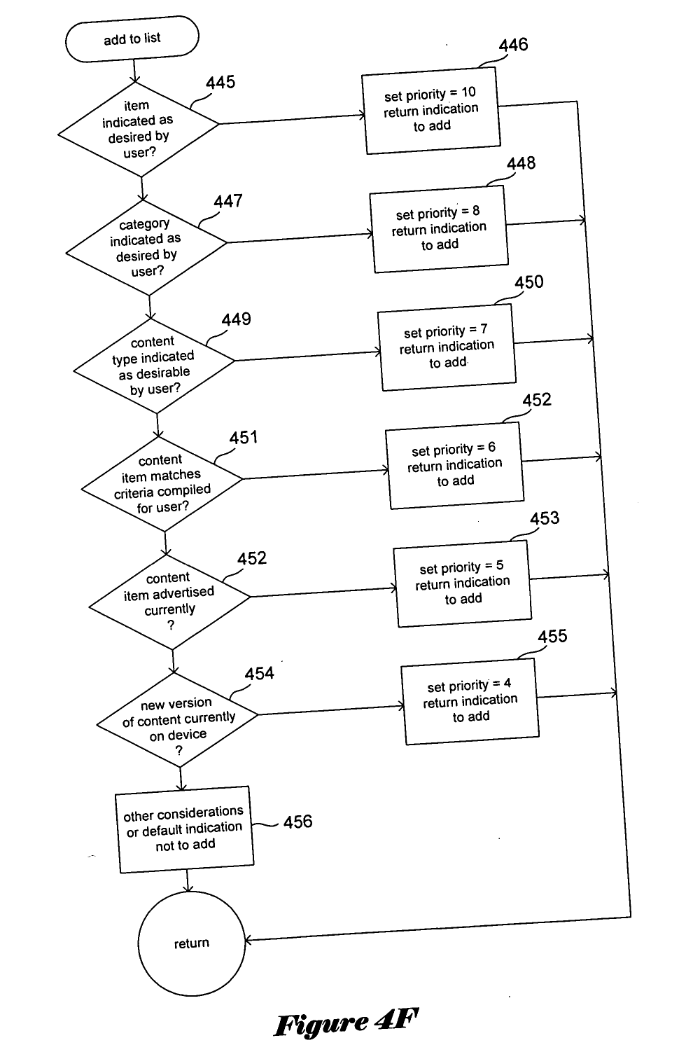

FIGS. 4A-F include control-flow diagrams that illustrate one embodiment of a fill-up operation in which content is downloaded from a content server, kiosk, or other automated content provider to a portable electronic device. FIGS. 4A is a control-flow diagram showing the highest-level view of the fill-up operation. In step 402, the device connects to a virtual store provided by a content server, a kiosk, or other automated content provider. Connection involves a physical communications connection through a wireless or wire link and exchange of sufficient information for the electronic device to be recognized as a device belonging to a subscriber to content download from the virtual store. In general, the virtual store maintains a user profile for the owner of the portable, electronic device that contains connection information, billing information, addresses, account information, information about the user's various electronic devices, and information concerning the content desired by the user and the content provided to the user on a subscription basis. In connection step 402, the virtual store and portable, electronic device establish a two-way communications connection. In addition, the virtual store identifies the user of the portable, electronic device and locates and accesses the user's profile, in preparation for subsequent steps. Finally, the virtual store initializes local memory resources in preparation for compiling information in order to carry out subsequent steps in transactions over the two-way communications link. Next, in step 403, the portable, electronic device and virtual store undertake a certificate-based content acquisition authorization protocol in order to establish authorization for the portable, electronic device to receive content from the virtual store. In many embodiments, the portable, electronic device transmits sufficient information for the virtual store to access a third-party certificate-based authorization system in order to identify the user of the portable, electronic device as an authorized content receiver. Many other content-acquisition authorization methods may be used in alternative embodiments. Once the preliminary steps 402 and 403 are complete, the virtual store then analyzes the current contents of the portable, electronic device, in step 404, in preparation for downloading content to the portable, electronic device. Following content analysis, the virtual store activates a fill-up button displayed by, or located on, the portable, electronic device so that a user can subsequently request a fill-up operation. Next, in step 408, a user subsequently selects the fill-up operation by inputting a selection request to the fill-up button displayed by, or located on, the user's portable, electronic device. In step 410, in response to selection of the fill-up operation by the user, the virtual store downloads content to the portable, electronic device in order to carry out the requested fill-up operation. Finally, in step 412, any other interactions or transactions desired by the user may be carried out over the established two-way communications link prior to termination of the two-way communications link. It should be noted that additional interactions may precede selection of the fill-up operation by the user in step 408.

FIG. 4B is a control-flow diagram illustrating content analysis by the virtual store of the content currently on the electronic, portable device, expanding step 404 in FIG. 4A. In step 414, the local variable space is set to equal the free space for content download currently available on the portable, electronic device. The free space can be determined by the virtual store by accessing the electronic, portable device, either by an explicit free-space request or by computing the available free space using device information in the user's profile and by analyzing content directories resident within the electronic, portable device. Next, in nested for-loops represented by steps 415-420, the virtual store identifies each content item currently resident within a user's device to determine whether or not the content item is overwriteable, and saves indications of whether or not the content items are overwriteable in local memory. In the outer for-loop that begins with step 415, the virtual store examines each type of content resident within the portable, electronic device. For each type of content, the virtual store downloads a content directory from the device in step 416. In alternative embodiments, the virtual store may access these content directories through the two-way communications link without downloading them. In certain embodiments, there may be complex, hierarchical directories for each type of content, and in these cases, the virtual store downloads or accesses a hierarchical directory tree or other complex data structure describing the content of the currently considered type stored within the portable, electronic device. In the inner for-loop of the nested for-loops, the virtual store examines each content item of the currently considered content type. In step 418, the virtual store determines whether or not the currently considered content item is overwriteable. Step 418 is expanded, below, in FIG. 4C.

FIG. 4C is a control-flow diagram illustrating determination, by the virtual store, of whether a content item currently resident within the portable, electronic device is overwriteable. In the described embodiment, this determination is essentially a hierarchical decision list, or rule list. In the described embodiment, each content item is either marked overwriteable or not overwriteable, although, in more sophisticated, alternative embodiments, overwrite priorities may be assigned to content items to indicate preferences or priorities for overwriting, so that content items most desirable for overwriting are first overwritten, before content items less desirably overwritten. If, according to the described embodiment of the present invention, the content item is marked by the user as “Do Not Delete,” as determined in step 421, then the content item is noted, in local, virtual-store memory as not deletable, in step 422. Otherwise, if the content item is marked for deletion by the user, as determined in step 423, then the variable space is updated, in step 424, to reflect the storage space recoverable by deleting the item and the item is marked as deletable, in step 425, in local virtual-store memory. If the item is older than a deletion threshold age, as determined in step 426, then the item is marked as deletable. Otherwise, if the item is in a category of items or content type it is marked for deletion, as determined in step 427, then the item is marked as deletable. In certain embodiments, access frequencies of items on the portable, electronic device are maintained by the portable, electronic device. In these embodiments, if the item has an access frequency lower than the threshold access frequency, as determined in step 428, then the item is marked as deletable. Otherwise, if there are additional reasons to mark the item as deletable, as determined in step 429, then the item is marked deletable. Otherwise, the item is marked as not deletable, in step 422.

FIG. 4D is a control-flow diagram that expands the device fill-up step 410 in FIG. 4A. In step 426, the virtual store determines the content within the virtual store eligible for downloading to the portable, electronic device, storing the downloadable content items in a sorted, prioritized list with the content items most desirable for downloading to the portable, electronic device occurring at the head of the sorted list. In step 427, the virtual store determines whether the space needed for downloading all of the content eligible for download to the portable, electronic device is greater than the free space for content downloading currently within the portable, electronic device. If there is insufficient free space within the portable, electronic device, then, in step 428, the virtual store deletes sufficient items marked as deletable, in step 418 of FIG. 4B, by the virtual store so that the free space within the portable, electronic device exceeds or equals the space needed for downloading the eligible content items. As discussed above, in certain embodiments, content items resident within the portable, electronic device are deleted in a deletion-preference order. In step 429, the virtual store again determines whether there is sufficient free space on the portable, electronic device for downloading all of the eligible content for downloading. If not, then in step 430, the virtual store takes, or requests from the portable, electronic device, a clean-up and compression operation by which the content is reorganized within the portable, electronic device, following deletion of content in step 428, to maximize the amount of free space available within the portable, electronic device. Following completion of this step, the amount of free space within the device is a maximum amount of free space available under current conditions. Whether currently stored items are deleted, or the amount of free space on the portable, electronic device was sufficient, as determined in step 427, the virtual store then, in the for-loop represented by steps 431-435, proceeds to iteratively select the next content item for download from the sorted list of content items prepared in step 426 and download the item to the portable, electronic device in step 433 while there is a sufficient amount of free space remaining on the portable, electronic device for downloading a next content item and while there is additional eligible content for downloading to the portable, electronic device.

FIG. 4E is a control-flow diagram that expands step 426 in FIG. 4D. FIG. 4E illustrates the process by which the virtual store determines the eligible content for download to the portable, electronic device. In step 436, the virtual store initializes a list of eligible content within local virtual-store memory and prepares to access the user's profile and other compiled information for the user. In the nested for-loops of steps 437-444, the virtual store considers each type of content and each content item for each type of content within the virtual store for downloading to the portable, electronic device. In the outer for-loop, beginning with step 437, the virtual store looks at each type of content to which the user subscribes. For each type of content, the virtual store accesses the directory or directory structure in which that type of content is stored, in step 438. Then, in the inner for-loop of steps 439-443, the virtual store examines each content item in the currently considered content type and determines, in step 440, whether or not to add the item to the sorted list of eligible items to download, assigning a preference to the content item as part of the consideration carried out in step 440. If the item is determined to be added, in step 441, then the item is added at the proper position within the list, in step 442.

FIG. 4F expands step 440, in FIG. 4E, in which the virtual store determines whether or not to add an item to the list of sorted content items for download, as well as assigning a priority to the item. In one embodiment of the present invention, the determination of whether or not to add an item to the list of items is a ordered list of rules. First, in step 445 of FIG. 4F, the virtual store determines whether or not the item has been marked by the user as desired for download. Users may mark items as desirable for download using various and virtual-store interfaces during which users browse and select items. If the item is marked as desirable for download by the user, then the priority for downloading is set to a high priority, such as the priority “10” used in FIG. 4F, and an indication that the items should be added to the list of items is returned, in step 446. Otherwise, if the category to which the item belongs has been indicated as desirable for download by the user, as determined in step 447, then the priority is accordingly set and an indication is returned to add the content item to the sorted list of items in step 448. Otherwise, if the type of the content has been indicated as desirable for download by the user, as determined in step 449, then the priority is accordingly set and an indication of adding the item to the sorted list is returned in step 450. Otherwise if a content item matches some criteria compiled by the user for download, as determined in step 451, then the priority is accordingly set and an indication of adding the content to the sorted list returned in step 452. Otherwise, if the content item is an item that is currently being promoted or advertised by the content provider, as determined in step 452, then the priority is accordingly set and the content item indicated for addition to the rest of the sorted items in step 453. If the time is a new version of a content item currently stored on the device, as determined in step 454, then the priority is accordingly set and an indication is returned to add the content, in step 455. In step 456 any other considerations may be applied to the content item, with content items deemed as desirable for download assigned priorities and indications returned for adding the content item to a list, and otherwise a default indication that indicates the content item should not be added to the sorted list is returned, in step 456.

Although the present invention has been described in terms of particular embodiments, it is not intended that the invention be limited to these embodiments. Modifications within the spirit of the invention will be apparent to those skilled in the art. For example, many additional types of criteria, methods for specifying and inferring desirable content and for determining content for deletion during a fill-up operation are possible. The fill-up operation can be implemented in a multitude of different programming languages for executing on many different operating systems and hardware platforms. The functionality needed for the fill-up operation may be partitioned in many different ways between portable, electronic devices and automated content-delivery systems.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for delivering content from an automated content-delivery system to a portable, electronic content-rendering device, the method comprising:
receiving a connection request from the portable, electronic content-rendering device;
establishing a connection between the automated content-delivery system and the portable, electronic content-rendering device;
analyzing the content current residing on the portable, electronic content-rendering device;
receiving a fill-up request from the portable, electronic content-rendering device;
selecting content for downloading to the portable, electronic content-rendering device;
preparing the portable, electronic content-rendering device for download of content; and
downloading content to the portable, electronic content-rendering device.

2. The method of claim 1 wherein establishing a connection between the automated content-delivery system and the portable, electronic content-rendering device further comprises:
establishing a communications link with the portable, electronic content-rendering device;
requesting from the portable, electronic content-rendering device identification information to identify the user of the portable, electronic content-rendering device;
receiving the requested identification information; and
identifying the user and locating information stored within the automated content-delivery system associated with the user.

3. The method of claim 2 wherein establishing a connection between the automated content-delivery system and the portable, electronic content-rendering device further comprises:
requesting from the portable, electronic content-rendering device information for authorizing the user to download content;
receiving the requested authorization information; and
using the requested authorization information to authorize the user for subsequent content downloading.

4. The method of claim 1 wherein analyzing the content current residing on the portable, electronic content-rendering device further comprises:
for each content item, resident in the portable, electronic content-rendering device, of each content type that may be downloaded by the user, determining whether the content item may be deleted and saving the determination of whether the content item may be deleted.

5. The method of claim 4 wherein a content item may be classified as deletable when:
the content item has been previously marked for deletion;
the content item is of a type previously marked for deletion;
the content item is of a category previously marked for deletion;
the content item was downloaded prior to a threshold date for content removal; or the content item has been less frequently accessed by the user than a threshold frequency of access for deletion.

6. The method of claim 4 wherein a content item may not be classified as deletable when:
the content item has been previously marked to not be deleted.

7. The method of claim 1 wherein selecting content for downloading to the portable, electronic content-rendering device further comprises:
for each content item, resident in the automated content-distribution device, of each content type that may be downloaded by the user, determining whether the content item is desirable for downloading during the requested fill-up operation and assigning a preference to the content item.

8. The method of claim 7 wherein a content item may be classified as desirable for downloading when:
the content item has been previously marked for downloading;
the content item is of a type previously marked for downloading;
the content item is of a category previously marked for downloading; or
the content item meets criteria for downloading maintained by the automated content-distribution system.

9. The method of claim 1 wherein preparing the portable, electronic content-rendering device for download of content further comprises:
determining whether additional space for content is needed on the portable, electronic content-rendering device in order to download selected content; and
when additional space is needed, deleting content from the portable, electronic content-rendering device determined to be deletable.

10. The method of claim 1 wherein downloading content to the portable, electronic content-rendering device further comprises:
downloading a next selected content item to the portable, electronic content-rendering device while selected content items remain for downloading and while sufficient space remains on the portable, electronic content-rendering device for storing the next selected content item.

11. Computer instructions encoded in a computer readable memory that implement the method of claim 1.

12. An automated content-distribution system that provides a fill-up operation according to the method of claim 1.

13. A portable, electronic content-rendering device that features or displays a fill-up-operation selection means and that receives content by the method of claim 1.
